(19) United States
(12) Patent Application Publication
(10) Pub. No.: US 2026/0226884 A1
(43) Pub. Date: Aug. 6, 2026

(54) AMPHIBIOUS ENERGY HARVESTING SYSTEM FOR WIND AND WATER ENERGY CONVERSION

(71) Applicant: NEW JERSEY INSTITUTE OF TECHNOLOGY, Newark, NJ (US)

(72) Inventors: Lin Dong, Warren, NJ (US); Brooke Flammang, Pennington, NJ (US); Chi Zhang, Harrison, NJ (US); Yuxiao Wang, Newark, NJ (US); Johan Urena, Newark, NJ (US); Richards Augustin-Lawson, Newark, NJ (US); Catherine Eno, Middletown, RI (US)

(73) Assignee: NEW JERSEY INSTITUTE OF TECHNOLOGY, NEWARK, NJ (US)

(21) Appl. No.: 19/468,515

(22) Filed: Feb. 3, 2026

Related U.S. Application Data
(60) Provisional application No. 63/753,132, filed on Feb. 3, 2025.

(51) Int. Cl. F03D 15/10; F03B 13/10; F03D 9/25; H02K 5/10; H02K 7/116; H02K 7/18; H02K 11/00; H02N 1/04

(52) U.S. Cl. CPC F03D 15/10; F03B 13/10; F03D 9/25; H02K 5/10; H02K 7/116; H02K 7/1823; H02K 11/0094; H02N 1/04; F05B 2220/706; F05B 2260/4031

(57) ABSTRACT

Disclosed are amphibious energy harvesting systems that include a hybrid triboelectric-electromagnetic generator (HTEG). A triboelectric nanogenerator (TENG) is mechanically coupled to an electromagnetic generator (EMG) in a gear-driven transmission configured to enable synchronized energy conversion. A TENG unit comprises a stator and rotor assembly. A stator is paired with a first triboelectric layer configured for soft-contact engagement with a second triboelectric layer paired with a rotor, where the engagement is maintained under compressive force from a sponge element connected to a driving gear. An amphibious turbine is configured to rotate the driving gear, which is mechanically coupled to a driven gear connected to an EMG unit. The turbine is configured for efficient energy harvesting in dynamic, dual-phase fluid environments. Dual generator system of the disclosure offers improved operational adaptability in shifting environmental conditions compared to conventional energy harvesting systems.

### RELATED APPLICATIONS

This application claims the benefit of United States Provisional Application No. 63/753,132 filed on February 3, 2025, the entirety of which is incorporated by reference herein.

### STATEMENT REGARDING FEDERALLY SPONSORED RESEARCH

This invention was made with government support under Agreement No. 2106459 awarded by the National Science Foundation and under Agreement No. N000142312130 awarded by the Department of Defense. The government has certain rights in the invention.

### FIELD OF THE DISCLOSURE

The present disclosure relates to systems and methods for energy harvesting. In particular, the present disclosure relates systems and methods for converting energy from multiple environmental sources, such as wind and water flow, into electrical energy using an amphibious turbine and multiple coordinated generators.

### BACKGROUND

Energy harvesting technologies have emerged as potential solutions for powering small, portable electronics in off-grid environments, particularly in outdoor applications. These technologies harness ambient energy from natural sources, such as wind, water, and human motion, to generate electricity. Among the various energy harvesting techniques, triboelectric nanogenerators (TENGs) and electromagnetic generators (EMGs) have gained prominence for their ability to convert mechanical energy into electrical energy. These systems typically operate in isolation, and operate to harvest energy from a single environmental source, such as wind or water flow. Further, each generator type typically requires specialized components, which restrict their versatility and utility for many applications. There is a growing need for renewable, portable power sources, particularly in outdoor, off-grid, and emergency scenarios.

Increasing demand for sustainable, off-grid energy generation has encouraged the development of hybrid systems that integrate multiple energy harvesting techniques to optimize performance in complex and shifting environmental conditions. Traditional systems have been designed to harvest energy from a single source, for example, turbines designed to harvest wind energy or watermills for hydropower, and offer optimal energy conversion efficiency only in high-flow conditions, being poorly calibrated to harvest energy in mild (e.g. low wind) conditions. To date, systems developed for multiple use settings require separate actuators and one or more structural or mechanical modifications to adapt for use in each setting. Separate, bulky components and slow, labor-intensive changeover protocols make these options less than ideal for use in remote settings, across multiple locations, and in harsh conditions where portability, resilience, and user-friendliness are premium considerations.

Accordingly, there is a need for new energy harvesting systems for multiple use settings.

### SUMMARY

In accordance with the embodiments of the present disclosure, systems and methods are provided for amphibious hybrid energy generation under variable environmental conditions, including wind and water flow.

In one embodiment, an amphibious energy harvesting system could comprise an electromagnetic generator (EMG) mechanically coupled to a driven gear; a triboelectric nanogenerator (TENG) mechanically coupled to a driving gear and connected with the EMG in an electrical circuit; and a turbine connected to the driving gear by a turbine shaft; wherein the driven gear is mechanically coupled to the driving gear, and rotation of the turbine activates the EMG and TENG to generate electrical output.

In accordance with embodiments of the present disclosure, the turbine could be configured for both aerodynamic and hydrodynamic loading.

In accordance with embodiments of the present disclosure, the TENG could be rectified and connected in parallel with the EMG in the electrical circuit.

In accordance with embodiments of the present disclosure, the TENG could operate at a rate of from 100 rpm to 400 rpm to generate an open-circuit voltage of from 8 V to 40 V, and the EMG could operate at a rate of 20 rpm to generate a current of about 20 mA.

In accordance with embodiments of the present disclosure, the TENG could include one or more electrodes, a second triboelectric layer, and a first triboelectric layer affixed to a distal face of a sponge; wherein a proximal face of the sponge is secured to the driving gear, and the one or more electrodes, second triboelectric layer, and first triboelectric layer are compressed together by a force maintained by the sponge.

In accordance with embodiments of the present disclosure, the amphibious energy harvesting system could further include a waterproof housing enclosing the TENG and EMG and including wire access to the electrical circuit; and a supporting plate sealed to the housing and configured to support the turbine.

In accordance with embodiments of the present disclosure, the turbine could be mounted to the supporting plate with a water-resistant ball bearing.

In accordance with embodiments of the present disclosure, the housing could be made from a lightweight durable material.

In accordance with embodiments of the present disclosure, the amphibious energy harvesting system could be portable with a volume of about 0.2 L to about 5 L.

In accordance with embodiments of the present disclosure, the amphibious energy harvesting system could be portable, having a weight of about 100 to 500g.

In accordance with embodiments of the present disclosure, the turbine, driving gear, and driven gear could be made from a material selected from polyethylene terephthalate glycol (PETG), polylactic acid (PLA), thermoplastic polyurethane (TPU).

In accordance with embodiments of the present disclosure, the amphibious energy harvesting system could further include an energy storage system selected from a supercapacitor, battery, or capacitor-battery hybrid, for receiving and storing the electrical output.

In accordance with embodiments of the present disclosure, the TENG could generate AC electrical output, the amphibious energy harvesting system could further comprise a power management unit configured to rectify AC electrical output from the TENG into a DC output and combine the DC output with the electrical output from the EMG to yield synchronized DC electrical output suitable for charging an energy storage system or external device.

In accordance with embodiments of the present disclosure, the driven gear could have a transmission ratio with the driving gear of from 0.05:1 to 1:1.

In one embodiment, a method of generating electrical energy could include steps of exposing a turbine to wind or water flow to induce turbine rotation; activating a triboelectric nanogenerator (TENG) mechanically coupled to the turbine to generate electrical energy by triboelectrification; and, activating an electromagnetic generator (EMG) mechanically coupled to the turbine to generate electrical energy via electromagnetic induction.

In accordance with embodiments of the present disclosure, methods of generating electrical energy could further include rectifying the electrical energy generated by the TENG into a DC output and combining the DC output with electrical energy generated by the EMG to yield a synchronized DC electrical output suitable for charging an energy storage system or external device.

In accordance with embodiments of the present disclosure, methods of generating electrical energy could further include controlling a flow of the electrical energy generated by the TENG and EMG to one or more energy storage systems or external devices responsive to real-time power demand.

In one embodiment, a method of assembling a hybrid energy generator system could include steps of securing a triboelectric nanogenerator (TENG), an electromagnetic generator (EMG), and a turbine to a supporting structure; connecting the TENG to a driving gear with a compressive element configured to maintain triboelectric contact between components of the TENG; connecting the turbine to the driving gear; and engaging the driving gear with a driven gear mechanically coupled to the EMG to form a transmission system.

In accordance with embodiments of the present disclosure, assembling a hybrid energy generator system could further include encasing the system in a waterproof housing.

In accordance with embodiments of the present disclosure, the transmission system could have a transmission ratio configured to amplify the rotation speed of the EMG at low turbine speeds.

Any combination and/or permutation of the embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the amphibious energy harvesting system and associated systems and methods of the present disclosure, reference is made to the accompanying figures, wherein:

FIG. 1 show a perspective view of an amphibious hybrid triboelectric and electromagnetic generator (HTEG) system in accordance with one embodiment of the present disclosure;

FIG. 2 illustrates certain components of a triboelectric nanogenerator (TENG) in accordance with embodiments of the present disclosure;

FIG. 3 shows an exploded view of the assembly of an amphibious HTEG system in accordance with embodiments of the present disclosure;

FIG. 3A shows a circuit diagram of a HTEG in accordance with embodiments of the present disclosure;

FIG. 4 is a graphical depiction of voltage and power output from a TENG with variable loading resistance in accordance with embodiments of the present disclosure;

FIG. 5 is a graphical depiction of voltage and power output from an EMG with variable loading resistance in accordance with embodiments of the present disclosure;

FIG. 6 is a graphical depiction of voltage and power output from a HTEG with variable loading resistance in accordance with embodiments of the present disclosure;

FIG. 7 shows a graph comparing the charging performance of a HTEG, TENG, and EMG in accordance with embodiments of the present disclosure;

FIG. 8 is a graphical depiction of the voltage generated by an amphibious HTEG in accordance with embodiments of the present disclosure under different wind speeds;

FIG. 9 is a graphical depiction of the charging performance of an HTEG in accordance with embodiments of the present disclosure;

FIG. 10 is a graphical depiction of the voltage generated by a HTEG in accordance with embodiments of the present disclosure under different water flow rates;

FIG. 11 illustrates a method for constructing a TENG in accordance with embodiments of the present disclosure;

FIG. 12 illustrates a method for constructing an EMG in accordance with embodiments of the present disclosure; and,

FIG. 13 illustrates a method for constructing a HTEG system in accordance with one embodiment of the present disclosure.

### DETAILED DESCRIPTION

Systems and methods of the disclosure provide multiple energy harvesting pathways mechanically and electrically integrated in a single device. Power management circuits of the disclosure are configured to rectify generated output from a triboelectric nanogenerator and combine with simultaneously-generated output from an electromagnetic generator to yield a stable, hybrid-generated DC current suitable for, inter alia, charging a connected battery or for direct supply to connected electronic devices.

Prior to the present disclosure, there is a need for systems that leverage the abilities of multiple generator formats to optimize efficiency and output in settings where multiple energy sources may be available, or where any one energy source (e.g., wind or water flow) may be inconsistent. There is also a need for systems that can be used to harvest energy in a setting where one condition predominates, and can be relocated to harvest energy in another setting where a different condition predominates. Recognizing the potential advantages of harnessing the operational capabilities of multiple different generator formats, numerous approaches have been taken to develop hybrid systems in which multiple energy conversion pathways contribute harvested energy to a combined output. Many such systems are engineered so that separate generators, such as, in some examples, triboelectric and electromagnetic generators, undergo alternating operation in response to change in environmental conditions. There is still a need for systems in which multiple different generator types can operate simultaneously to harvest as much available energy from a given environment is possible, and in which the energy harvested by each generator can converge to a single stream in an appropriate form for desired uses.

The design of integrated multi-generator hybrid systems can be challenging. Considerations involved in the design of integrated multi-generator hybrid systems include, but are not limited to, the choice of energy harvesting implement, the integration of the converted energy output from each type of generator, and the collection and/or transmission of the integrated energy for its desired use.

Regarding the energy harvesting implement (e.g. the sail of a windmill, the photovoltaic material of a solar cell), for hybrid generator systems it is desirable to use a single implement that (1) can harvest energy from multiple sources (e.g. wind flow and water flow), (2) can harvest energy over a range of intensities (e.g. can be active even in low-flow conditions, and can withstand strong or turbulent conditions), and (3) can be coupled to each integrated generator so that each generator is activated in response to actuation of the single harvesting implement. Size, shape, and material choice for the harvesting implement can be customized according to system needs depending on the types of generators used and intended applications. For example, in the case of a turbine, rotational balance and torque transfer can be optimized relative to anticipated flow conditions and to match desired electrical output ranges.

Regarding integration of energy output from each generator, system circuitry can be designed so that electrical output in different modes (e.g., alternating vs. direct current) at different intensities can be combined in a way that allows multiple generators to operate simultaneously with variable output in response to a load that may vary over a substantial range. Parameters such as mismatched impedance, working frequency, and polarity of different generator types and their components can be accounted for to design integrated circuits that yield a combined, hybrid power output. Triboelectric generators, for example, generate high-voltage, pulsed output poorly suited for direct charging applications. The system and circuitry can be engineered to yield hybrid output optimized for, e.g., stability in dynamic load conditions, maximized total output over a given time period, or subsequent use which can include battery storage, device powering, distance transmission, or combinations thereof.

Regarding collection or transmission of the hybrid output, hybrid energy harvesting systems should provide for safe, efficient distribution of generated power taking into account the harvesting environment and the power recipients. For aqueous energy harvesting settings, for example, hybrid generator systems can be built into closed devices with waterproof housing, and line-out electrical connections configured to avoid water damage to the system or external connections. For energy storage applications, the circuitry and housing should allow for integration of a capacitor, battery, or similar within the apparatus, as well as for secure external connection for discharging energy stored therein.

Besides the mechanical and electrical challenges of developing such an integrated, hybrid energy harvesting system, an additional goal depending on target application is to design systems that can be scaled in size and weight for portable use and which are configurable for inclusion in sturdy, user-friendly apparatuses that can be resistant to conditions as necessary for reliable use in real-world settings. Compact, portable systems and devices with rugged, water-resistant construction are desirable for industrial or recreational energy generation applications in which the use of multiple devices, or arduous reconfiguration of an adaptable device, would be inefficient or impractical.^{[1-10]} Portable, versatile energy generating systems of this nature can offer improved usefulness for a variety of emergency and off-grid generation applications compared to existing single-format energy harvesting systems.

Systems and methods of the present disclosure may overcome the limitations of traditional energy harvesting systems that operate in isolation, focusing solely on either wind or water energy. With multiple energy harvesting pathways mechanically and electrically integrated in a single system, the hybrid systems and methods disclosed herein provide versatile, adaptable solutions for capturing energy with improved ease and efficiency from both wind and water sources, improving the accessibility of off-grid power generation.

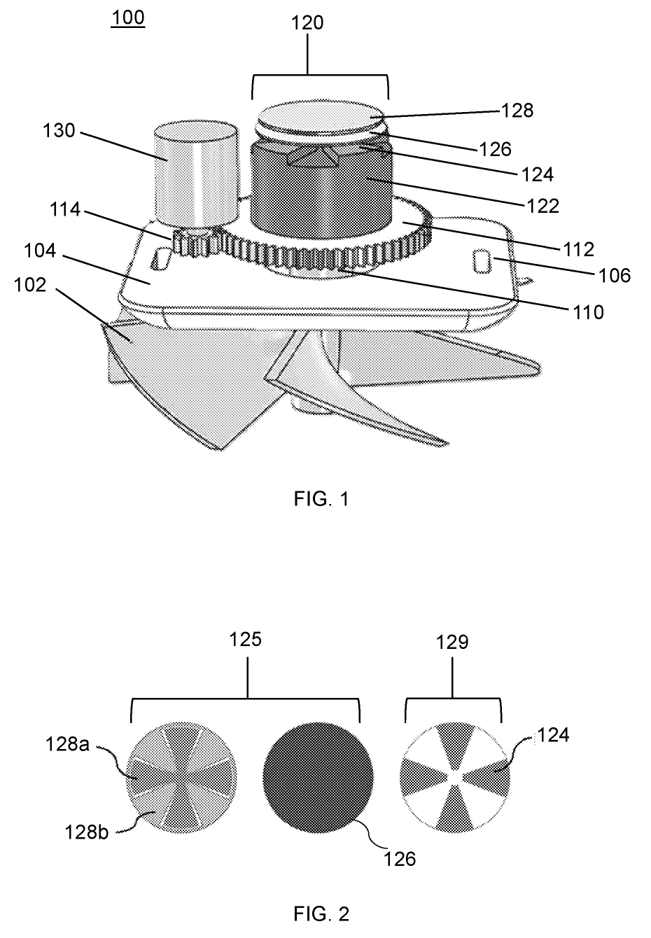

FIG. 1 shows a perspective view of an exemplary embodiment of a hybrid triboelectric-electromagnetic generator (HTEG) system 100 of the present disclosure. The HTEG could include a triboelectric nanogenerator (TENG) 120 connected to an electromagnetic generator (EMG) 130 by a coupling mechanism. In exemplary embodiments, the coupling mechanism includes a transmission mechanism comprising a gear set comprising a driving gear 112 and a driven gear 114. FIG. 2 shows certain components of the TENG unit 120, which could include a stator 125 and rotor 129 assembly. As shown in FIG. 2, the stator 125 could include electrodes 128 (e.g., inner electrodes 128a and outer electrodes 128b) and a first triboelectric layer 126, and the rotor 129 could include a second triboelectric layer 124 adhered to a distal face of a compressive element 122. In one or more embodiments, the stator 125 and rotor 129 are compressed together under a consistent force maintained by the compressive element 122. In one or more embodiments, as shown in FIG. 2, electrodes 128 may have a periodic structure. In exemplary embodiments, the stator 125 integrates copper electrodes with complementary inner and outer electrode patterns, and is paired with a first triboelectric layer 126 to generate triboelectric charges. It will be understood that other electrode materials could be employed, such as aluminum, gold, silver, and platinum. In one or more embodiments, first triboelectric layer 126 may be a nylon layer, such as a nylon film, although it will be understood that materials other than nylon could be used for the first triboelectric layer 126, including, but not limited to polypropylene, polyethylene terephthalate, and polyethylene. The rotor 129 can include a second triboelectric layer 124 that interacts with the stator using a soft-contact mechanism to minimize wear and operational resistance associated with frictional motion (FIG. 2). In an exemplary embodiment, second triboelectric layer is a patterned PTFE film. In some embodiments the second triboelectric layer 124 includes a polymer material such as polyimide, polyurethane, polystyrene, polyvinyl chloride, and rubber. The second triboelectric layer 124 could also be an inorganic layer comprising, in a non-limiting example, silica (SiO₂). It will be understood that first triboelectric layer 126 and second triboelectric layer 124 could each independently be in the form of a film, or in the form of a wafer, textile, or other appropriate material type.

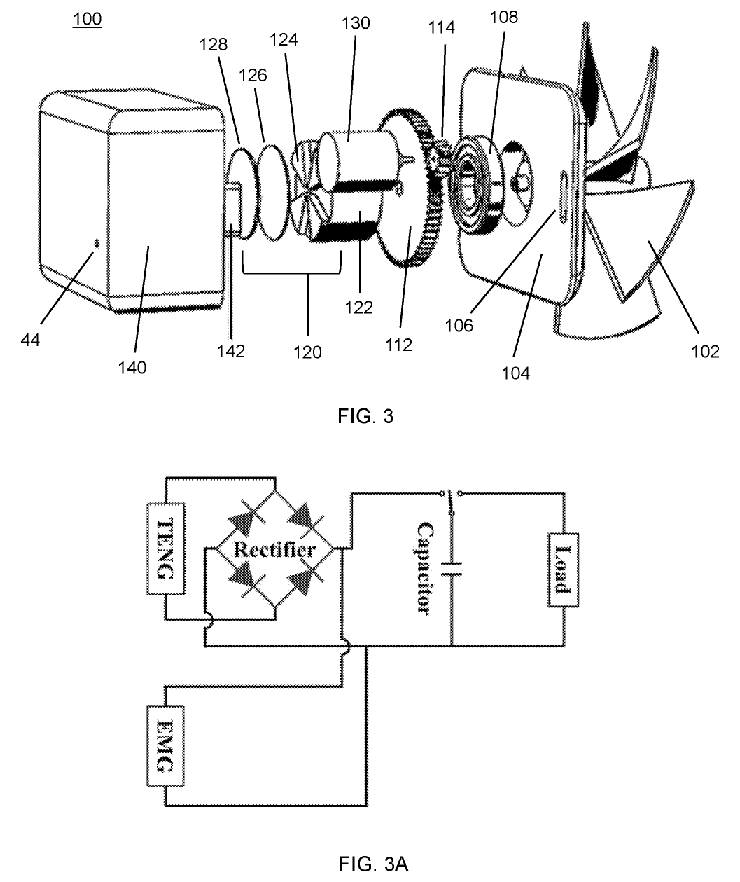

A proximal face of compressive element 122 may be adhered to a surface of a driving gear 112 to connect the TENG 120 to the transmission. Driving gear 112 has pinions sized to interlock with pinions of driven gear 114 which is coupled to the EMG 130 and transmits rotational motion to the EMG. The HTEG system 100 further includes a turbine 102 connected with a turbine shaft 110. In one or more embodiments, as shown in FIG. 3, the turbine 102 is mounted on a supporting plate 104 via a standardized water-resistant ball bearing 108. The turbine 102 is connected by the turbine shaft 110 to the driving gear 112, such that actuation (i.e., rotation) of the turbine 102 causes rotation of the driving gear 112. As shown in the amphibious HTEG system 100 depicted in FIG. 3, embodiments of the disclosure can include a housing 140 to protect the HTEG. In one or more embodiments, housing 140 is a waterproof or water-resistant housing. Housing 140 could include one or more watertight access ports 144 to provide access for wires connecting the HTEG to external sources. Housing 140 may further include one or more sealing pegs 142 configured to fit securely into sealing inlets 106 in supporting plate 104 to seal the housing 140 to supporting plate 104, enclosing the HTEG within. The junction of housing 140 with supporting plate 104 may be sealed with a marine-grade sealant. In one or more embodiments, an inner surface of housing 140 may include one or more structural features configured to support, stabilize, or immobilize one or more elements of the HTEG, including, but not limited to, a cover of the EMG 130. In one or more embodiments, stator 125 of the TENG 120 may be affixed to the interior surface of housing 140 which may provide for continuous compression of TENG stator 125 with rotor 129, as discussed further herein.

In one or more embodiments, the entirety of housing 140 and supporting plate 104 may be formed (e.g., 3D-printed) from durable, non-corrosive material including, but not limited to, such as polyethylene terephthalate glycol (PETG) or polylactic acid (PLA). In one or more embodiments, to withstand environmental challenges, the transmission system can use laser-cut acrylic gears to promote functionality in harsh conditions, such as heavy rain or submersion in water. Use of lightweight materials also facilitates portability, making the systems of the disclosure suitable for various deployment scenarios. The turbine, driving gear, and driven gear could be made from a polymeric material, such as a thermoplastic material. For example, the material may be selected from, but is not limited to, PETG, PLA, thermoplastic polyurethane (TPU), or other 3D-printable or moldable polymers.

According to embodiments of the present disclosure, turbine 102 rotates when exposed to wind or water flow. Mechanical energy harvested from the wind or water flow transfers via turbine shaft 110 to the driving gear 112, and thus to compressive element 122 of the TENG 120 attached thereto. In this way, actuation of turbine 102 activates TENG unit 120, as discussed further herein. In one or more systems of the present disclosure, TENG operation includes triboelectrification and electrostatic induction caused by interactions of elements of the stator 125 and rotor 129, embodiments of which are illustrated in FIG. 2.

In exemplary embodiments, energy from wind or water flow causes rotation of turbine 102, which causes rotation of the rotor component 129 of the TENG 120 as described above. In one or more embodiments, rotor 129 comprises a compressive element 122, such as a sponge, and a second triboelectric layer 124, such as PTFE, adhered on a face of the compressive element 122 opposite from the face that is secured to driving gear 112. Compressive element 122 provides a sustained force that presses second triboelectric layer 124 against stator 125. Specifically, compressive element 122 serves to maintain a force that presses second triboelectric layer 124 against first triboelectric layer 126 of the stator component 125, which remains in a fixed position. With this compression in place, rotation of the rotor 129 induces friction between the second triboelectric layer 124 and the first triboelectric layer 126, generating negative triboelectric charges on the second triboelectric layer 124 and positive triboelectric charges on the first triboelectric layer 126, as dictated by the triboelectric series. By the resulting triboelectric effect, the total charge on the first and second triboelectric layers is equivalent, but the density of the charge that accumulates on second triboelectric layer 124 may be greater than the charge that accumulates on the first triboelectric layer 126 if the area of second triboelectric layer 124 is less than the area of first triboelectric layer 126. In one or more embodiments, for example, rotation of the rotor may induce a charge density on a second triboelectric layer, such as a PTFE film, that is double the charge density induced on a first triboelectric layer, such as a nylon layer, due to a lesser area of the PTFE film relative to the nylon film.

In one or more embodiments of the disclosure, TENG operation can be defined in three phases. In an initial phase, second triboelectric layer 124 is rotated into a position that axially aligns with inner copper electrodes 128a, inducing positive charges on inner electrodes 128a and negative charges on outer electrodes 128b. In an active phase, rotation of the second triboelectric layer 124 causes electrons to flow in a first direction from outer electrodes 128b to inner electrodes 128a through a load, such as a resistive element or one or more electronic components. The resulting current continues to flow until the second triboelectric layer 124 reaches a third phase, in which the charge polarity reverses relative to the initial phase. Continued rotation from there induces a current in the opposite direction, thereby generating alternating current (AC) due to a periodic structure of electrodes 128.

As shown in the embodiment of FIG. 1, driving gear 112 engages with driven gear 114 to form a transmission that further transmits rotational motion from turbine 102. Thus, the same rotation of the turbine that causes rotation of the driving gear 112 and activation of TENG 120, causes synchronized rotation of driven gear 114 and activation of EMG 130. In one or more embodiments, the transmission can have a ratio defined by the relative radiuses of the driving gear and driven gear. Selecting a transmission ratio in which the driven gear has a smaller radius than the driving gear can serve to amplify the rotation speed of the driven gear, and thus the mechanical energy transmitted to the EMG, to promote efficient output by the EMG even at low turbine speeds. In exemplary embodiments, the gear system can have a transmission ratio of 0.125:1. Exemplary transmission ratios include, but are not limited to, 0.05:1, 0.06:1, 0.07:1, 0.08:1, 0.09:1, 0.1:1, 0.11:1, 0.12:1, 0.13:1, 0.14:1, 0.15:1, 0.16:1, 0.17:1, 0.18:1, 0.19:1, 0.2:1, 0.225:1, 0.25:1, 0.3:1, 0.4:1, 0.5:1, 0.6:1, 0.7:1, 0.8:1, 0.9:1, 1:1, or any range therebetween.

In one or more embodiments of the present disclosure, the EMG 130 includes a highly efficient coil-and-magnet assembly in which magnets are strategically aligned with multiple turns of copper wire in the stator, enabling electromagnetic induction during rotation.

In accordance with the present disclosure, the size of one or more embodiments, such as those shown in FIGS. 1 and 3, can be scaled to achieve compact dimensions suitable for a portable amphibious HTEG device, measuring for example 10 cm × 15 cm × 15 cm in one embodiment, make it suitable for portable power generation applications and for harvesting energy in compact settings. Exemplary sizes of the HTEG include volumes of about 0.2 L to about 5 L, such as about 0.2 L, 0.3 L, 0.4 L, 0.5 L, 0.6 L, 0.7 L, 0.8 L, 0.9 L, 1 L, 1.5 L, 2 L, 2.5 L, 3 L, 3.5 L, 4 L, 4.5 L, 5 L, or any range therebetween and/or weights of about 50 grams to about 1,000 grams, such as about 50, 100, 150, 250, 300, 350, 400, 450, 500, 550, 600, 700, 800, 900, 1,000 grams, or any range therebetween.

FIG. 3A shows a circuit diagram of an exemplary electrical integration of a HTEG in accordance with the present disclosure. In this example, a TENG and EMG are connected in parallel. An alternating current output from the TENG is routed through a rectifier to convert the output into a direct current signal, which is then combined with a rectified or direct current output from the EMG. The combined output can be delivered to an external load, such as a resistive element or one or more electronic components for power delivery, energy storage or use, or further power management.

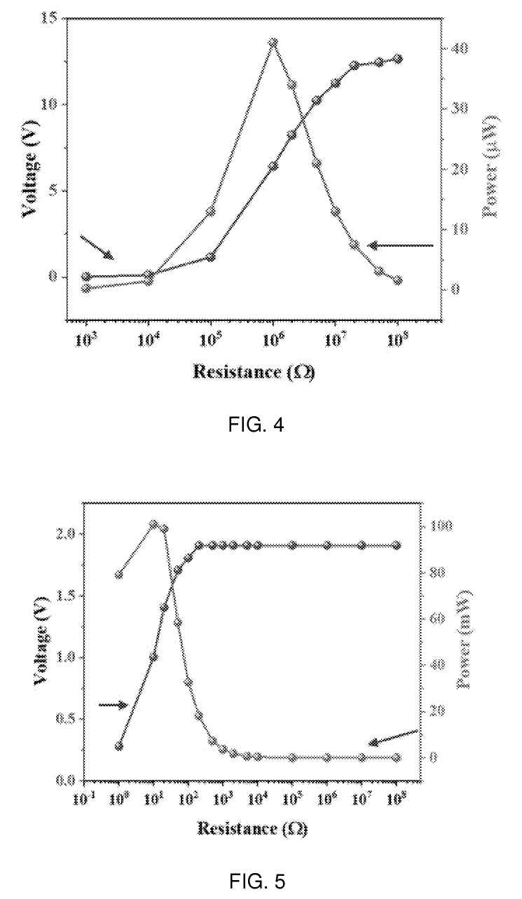

Amphibious hybrid energy harvesting systems and components of the present disclosure were tested to assess performance as discussed herein. A DC motor was employed to drive the turbine at target rotational speeds, simulating wind and water flows. A variable resistor was employed as an external load to assess the power output of a TENG operating at a constant 300 rpm. The results shown in FIG. 4 demonstrate that, when connected through a rectifier, the voltage across the resistor increased with resistance, peaking at 41 μW with a 1 MΩ load resistance. The significantly high internal impedance of the TENG accounted for the relatively low power output.

The same testing protocol was used to evaluate the performance of the EMG. The results shown in FIG. 5 demonstrate that the EMG unit operating at a constant 300 rpm achieved a peak power output of 101 mW at a 10 Ω load resistance. Thus, the EMG unit exhibited an opposite performance trend of the TENG, that is, high power output at lower resistance levels.

The same testing protocol was used to evaluate the performance of an integrated HTEG energy harvesting system of the present disclosure.

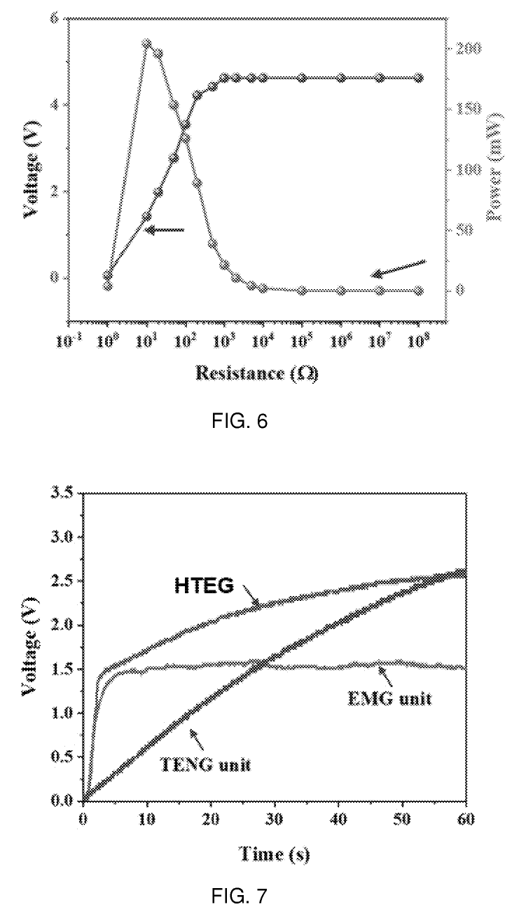

The results shown in FIG. 6 demonstrate that this hybrid system, configured as shown in the diagram of FIG. 3A, leverages the high voltage generation from the TENG unit and the high power generation from the EMG unit to achieve a balanced combination of high power output and high voltage generation, optimizing overall energy harvesting efficiency over a range of resistance. As FIG. 6 shows, at a constant 300 rpm the hybrid generator achieved a maximum power output of 204 mW at a loading resistance of 10 Ω, i.e. significantly greater output than the EMG or the TENG individually, and also significantly greater than the sum of the individual outputs of each generator.

Systems of the present disclosure notably offer high sensitivity to low-speed environmental input, such as mild wind or water flow conditions. In some embodiments, wind speed as low as 1.56 m/s and water flow rate as low as only 3.8 L/min are sufficient to initiate energy harvesting. An integrated HTEG energy harvesting system of the present disclosure achieved a peak power output of 204 mW operating at 300 rpm, far exceeding what would be expected from a simple combination. In one embodiment, the turbine is configured to generate 204 mW at 6.5 mph wind speed or 16 L/min water flow rate.

The charging performance of a TENG, an EMG, and an integrated HTEG energy harvesting system of the present disclosure were compared by activating each device at a constant 300 rpm. The results shown in FIG. 7 demonstrate that the TENG exhibited slow charging behavior, with the capacitor voltage gradually increasing to 2.6 V over 60 seconds. In contrast, the EMG unit charged the capacitor to 1.4 V within 5 seconds, after which further voltage increase was limited by the EMG’s characteristic low voltage output. Of note, the HTEG yielded a charging curve demonstrating a distinct two-stage process. In a first stage, the capacitor voltage surged sharply to 1.5 V within 5 seconds, driven by the high power output and rapid charging capability of the EMG unit. In a second stage, the voltage gradually increased from 1.5 V to 2.6 V over 55 seconds, as the TENG unit continued to charge the capacitor. This two-stage charging behavior highlights the HTEG’s superior performance, combining both high voltage and fast charging capabilities to exceed the performance of either the TENG or EMG unit alone.

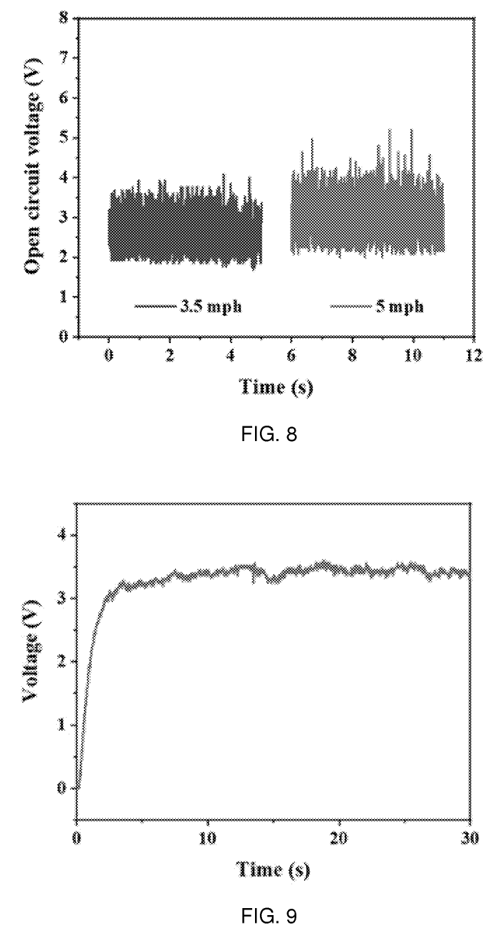

An integrated HTEG energy harvesting system of the present disclosure was tested in wind energy harvesting experiments conducted within a controlled wind tunnel environment. The results shown in FIG. 8 reveal that the HTEG of the present disclosure demonstrated an open-circuit voltage of approximately 3.5 V at a wind speed of 3.5 mph, showcasing its capability to operate efficiently under low-speed wind conditions. Further, the output voltage exhibited a linear increase with rising wind speeds, achieving significantly enhanced power outputs at 5 mph wind speed. This scalability underscores the HTEG’s adaptability for varied wind conditions.

The charging performance of an integrated HTEG energy harvesting system of the present disclosure was evaluated under 3.5 mph wind conditions. The results shown in FIG. 9 demonstrate that the HTEG was able to charge a 1000 μF capacitor to a voltage of 3.5 V in less than 15 seconds under 3.5 mph wind, proving its ability to deliver rapid energy storage. The stored energy was sufficient to power low-consumption electronic devices, including light-emitting diodes (LEDs). Such performance highlights the utility of hybrid energy systems of the disclosure for powering small-scale electronics under common environmental conditions.

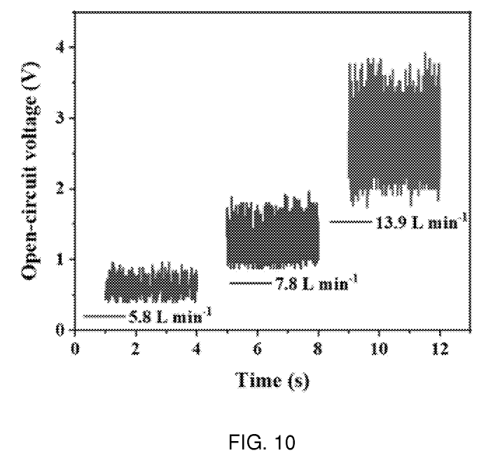

The charging performance of an amphibious HTEG energy harvesting system of the present disclosure was evaluated under variable water flow conditions. A column of water flow was directed at the system turbine with controlled speed and orientation. As shown in FIG. 10, the HTEG generated an open-circuit voltage that gradually increased with water flow rate, reaching a maximum voltage of 3.6 V at a flow rate of 13.9 L·min⁻¹. Without wishing to be bound by any particular theory, the observed enhanced voltage generation may be attributed to simultaneous increases in the output voltages of the TENG and EMG units. For example, increased water flow can induce amplified triboelectric charge generation by the TENG per unit time. This process resulted in an increased electrical energy output between the inner and outer copper electrodes. Similarly, elevated revolution speeds can cause the intersection of a greater number of magnetic flux lines by coils of the EMG per unit time, thereby enhancing electromagnetic energy generation. These synergistic effects demonstrate the HTEG’s capability for efficient water energy harvesting.

Thus, in one or more embodiments, the HTEG design, which integrates both the TENG and EMG units, achieves a balanced combination of high power output and high voltage generation, optimizing overall energy harvesting efficiency. This configuration allows the two units to operate as a unified system, with the dual-mode turbine exposed to wind or water flow. In embodiments of HTEG systems of the present disclosure, a TENG operating in a range of from 100 to 400 rpm generates an open-circuit voltage in a range of from 8 V to 40 V, and an EMG operating at 20 rpm generates a current of about 20 mA.

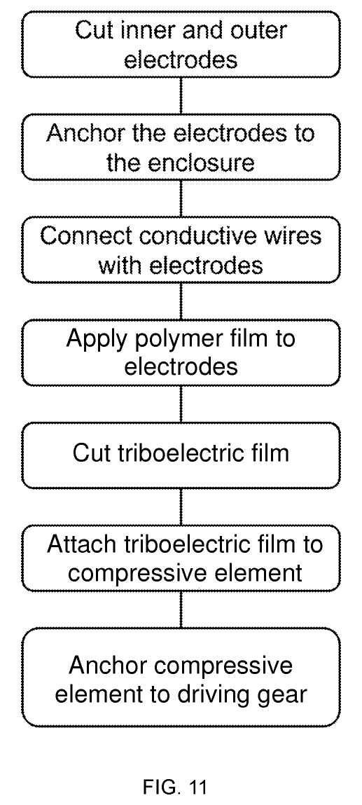

FIG. 11 outlines an exemplary embodiment of a process for assembling a TENG. In the embodiment, the fabrication process begins with cutting the inner and outer electrodes, followed by anchoring the electrodes to an enclosure. Conductive wires are then connected to the electrodes, and a first triboelectric layer, such as nylon film, is attached to the electrodes. Next, a second triboelectric layer, such as a polytetrafluoroethylene (PTFE) film, is cut and attached to a compressive element, such as a sponge. The sponge with the attached second triboelectric layer is then anchored to a driving gear to assemble the TENG.

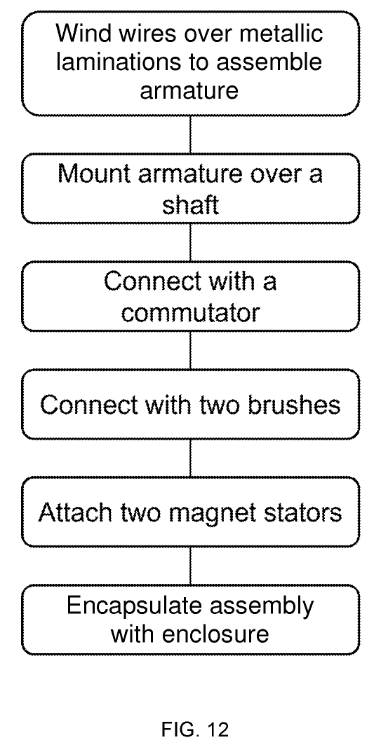

An exemplary embodiment of a method for assembling an EMG is illustrated in FIG. 12. In the embodiment, the steps include winding conductive wires, such as copper wires, over metallic laminations, such as steel laminations to form an armature. The armature can be mounted onto a shaft and connected to a commutator. The commutator is then connected to two brushes, followed by the attachment of two magnet stators. Finally, the assembly is encapsulated with a steel cover.

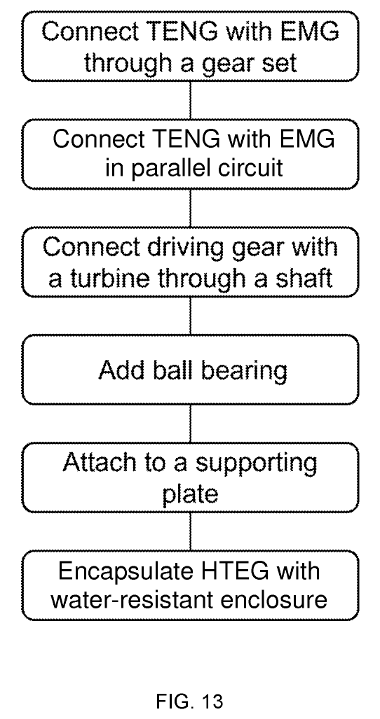

An exemplary embodiment of a method to integrate a TENG unit with an EMG unit to form a HTEG system is illustrated in FIG. 13. In one or more embodiments of the present disclosure, a TENG can be mechanically coupled to an EMG through a gear set, or transmission, and wired in parallel in an electrical circuit. A driving gear coupled to the TENG can then be connected to a turbine via a shaft. A ball bearing is then added, and the assembly is attached to a supporting plate, followed by encapsulation with a housing.

The materials and the methods of the present disclosure used in exemplary embodiments are described herein. While the embodiments discuss the use of specific materials, it is understood that the present disclosure could employ other suitable materials. Similar quantities, sizes, or measurements may be substituted without altering the method embodied herein.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

### References

[1] Y. Feng, L. Zhang, Y. Zheng, D. Wang, F. Zhou, W. Liu, Leaves based triboelectric nanogenerator (TENG) and TENG tree for wind energy harvesting, Nano Energy 55 (2019) 260-268. https://doi.org/10.1016/j.nanoen.2018.10.075.

[2] X. Chen, L. Gao, J. Chen, S. Lu, H. Zhou, T. Wang, A. Wang, Z. Zhang, S. Guo, X. Mu, Z.L. Wang, Y. Yang, A chaotic pendulum triboelectric-electromagnetic hybridized nanogenerator for wave energy scavenging and self-powered wireless sensing system, Nano Energy 69 (2020) 104440. https://doi.org/10.1016/j.nanoen.2019.104440.

[3] S. Zhang, Z. Jing, X. Wang, K. Fan, H. Zhao, Z.L. Wang, T. Cheng, Enhancing Low-Velocity Water Flow Energy Harvesting of Triboelectric–Electromagnetic Generator via Biomimetic-Fin Strategy and Swing-Rotation Mechanism, ACS Energy Letters 7(12) (2022) 4282-4289. https://doi.org/10.1021/acsenergylett.2c01908.

[4] Y. Pang, Y. Fang, J. Su, H. Wang, Y. Tan, C. Cao, Soft Ball-Based Triboelectric–Electromagnetic Hybrid Nanogenerators for Wave Energy Harvesting, Advanced Materials Technologies 8(6) (2023) 2201246. https://doi.org/10.1002/admt.202201246.

[5] K. Zhao, Z. Song, Z. Gao, W. Gao, M.-J. Liu, B. Gu, J. Guo, Y.-L. Chueh, High-performance triboelectric-electromagnetic hybrid nanogenerator using dual-functional flexible neodymium iron boron/ethyl cellulose (NdFeB/EC) composite films for wind energy scavenging, Chemical Engineering Journal 489 (2024) 150763. https://doi.org/10.1016/j.cej.2024.150763.

[6] N.D. Huynh, Z.-H. Lin, D. Choi, Dynamic balanced hybridization of TENG and EMG via Tesla turbine for effectively harvesting broadband mechanical pressure, Nano Energy 85 (2021) 105983. https://doi.org/10.1016/j.nanoen.2021.105983.

[7] Y. Guo, Y. Chen, J. Ma, H. Zhu, X. Cao, N. Wang, Z.L. Wang, Harvesting wind energy: A hybridized design of pinwheel by coupling triboelectrification and electromagnetic induction effects, Nano Energy 60 (2019) 641-648. https://doi.org/https://doi.org/10.1016/j.nanoen.2019.03.094.

[8] Q. Zhang, L. Li, T. Wang, Y. Jiang, Y. Tian, T. Jin, T. Yue, C. Lee, Self-sustainable flow-velocity detection via electromagnetic/triboelectric hybrid generator aiming at IoT-based environment monitoring, Nano Energy 90 (2021) 106501. https://doi.org/10.1016/j.nanoen.2021.106501.

[9] Y. Zhong, H. Zhao, Y. Guo, P. Rui, S. Shi, W. Zhang, Y. Liao, P. Wang, Z.L. Wang, An Easily Assembled Electromagnetic-Triboelectric Hybrid Nanogenerator Driven by Magnetic Coupling for Fluid Energy Harvesting and Self-Powered Flow Monitoring in a Smart Home/City, Advanced Materials Technologies 4(12) (2019) 1900741. https://doi.org/10.1002/admt.201900741.

C. Zhang, S. Yang, X. Dai, Y. Tu, Z. Du, X. Wu, Y. Huang, J. Fan, Z. Hong, T. Jiang, Z.L. Wang, Hybridized triboelectric-electromagnetic nanogenerators for efficient harvesting of wave energy for self-powered ocean buoy, Nano Energy 128 (2024) 109929. https://doi.org/10.1016/j.nanoen.2024.109929.

What is claimed is:

1. An amphibious energy harvesting system comprising:
an electromagnetic generator (EMG) mechanically coupled to a driven gear;
a triboelectric nanogenerator (TENG) mechanically coupled to a driving gear and connected with the EMG in an electrical circuit; and
a turbine connected to the driving gear by a turbine shaft;
wherein the driven gear is mechanically coupled to the driving gear, and rotation of the turbine activates the EMG and TENG to generate electrical output.

2. The amphibious energy harvesting system of claim 1, wherein the turbine is configured for both aerodynamic and hydrodynamic loading.

3. The amphibious energy harvesting system of claim 1, wherein the TENG is rectified and connected in parallel with the EMG in the electrical circuit.

4. The amphibious energy harvesting system of claim 1, wherein the TENG operating at a rate of from 100 rpm to 400 rpm generates an open-circuit voltage of from 8 V to 40 V, and the EMG operating at a rate of 20 rpm generates a current of about 20 mA.

5. The amphibious energy harvesting system of claim 1, wherein the TENG comprises one or more electrodes, a first triboelectric layer, and a second triboelectric layer affixed to a distal face of a sponge; wherein a proximal face of the sponge is secured to the driving gear, and the one or more electrodes, first triboelectric layer, and second triboelectric layer are compressed together by a force maintained by the sponge.

6. The amphibious energy harvesting system of claim 1, further comprising:
a waterproof housing enclosing the TENG and EMG and including wire access to the electrical circuit; and
a supporting plate sealed to the housing and configured to support the turbine.

7. The amphibious energy harvesting system of claim 6, wherein the turbine is mounted to the supporting plate with a water-resistant ball bearing.

8. The amphibious energy harvesting system of claim 6, wherein the housing is made from a lightweight durable material.

9. The amphibious energy harvesting system of claim 6, wherein the amphibious energy harvesting system is portable with a volume of about 0.2 L to about 5 L.

10. The amphibious energy harvesting system of claim 6, wherein the amphibious energy harvesting system is portable, having a weight of about 100 grams to about 500 grams.

11. The amphibious energy harvesting system of claim 6, wherein the turbine, driving gear, and driven gear are made from a material selected from polyethylene terephthalate glycol (PETG), polylactic acid (PLA), thermoplastic polyurethane (TPU).

12. The amphibious energy harvesting system of claim 3, further comprising an energy storage system selected from a supercapacitor, battery, or capacitor-battery hybrid, for receiving and storing the electrical output.

13. The amphibious energy harvesting system of claim 3, wherein the TENG generates AC electrical output, the amphibious energy harvesting system further comprising a power management unit configured to rectify AC electrical output from the TENG into a DC output and combine the DC output with the electrical output from the EMG to yield synchronized DC electrical output suitable for charging an energy storage system or external device.

14. The amphibious energy harvesting system of claim 1, wherein the driven gear has a transmission ratio with the driving gear of from 0.05:1 to 1:1.

15. A method of generating electrical energy, comprising the steps of:
exposing a turbine to wind or water flow to induce turbine rotation;
activating a triboelectric nanogenerator (TENG) mechanically coupled to the turbine to generate electrical energy by triboelectrification; and,
activating an electromagnetic generator (EMG) mechanically coupled to the turbine to generate electrical energy via electromagnetic induction.

16. The method of claim 15, further comprising rectifying the electrical energy generated by the TENG into a DC output and combining the DC output with electrical energy generated by the EMG to yield a synchronized DC electrical output suitable for charging an energy storage system or external device.

17. The method of claim 15, further comprising controlling a flow of the electrical energy generated by the TENG and EMG to one or more energy storage systems or external devices responsive to real-time power demand.

18. A method of assembling a hybrid energy generator system, comprising the steps of:
securing a triboelectric nanogenerator (TENG), an electromagnetic generator (EMG), and a turbine to a supporting structure;
connecting the TENG to a driving gear with a compressive element configured to maintain triboelectric contact between components of the TENG;
connecting the turbine to the driving gear; and
engaging the driving gear with a driven gear mechanically coupled to the EMG to form a transmission system.

19. The method of claim 18, further comprising encasing the system in a waterproof housing.

20. The method of claim 18, wherein the transmission system has a transmission ratio configured to amplify a rotation speed of the EMG at low turbine speeds.
